(19) United States
(12) Patent Application Publication
(10) Pub. No.: US 2014/0325614 A1
(43) Pub. Date: Oct. 30, 2014

(54) SYSTEM FOR PAIRING A TERMINAL WITH AN EGO ELEMENT WORN ON THE WRIST OR HAND OF A USER, AND CORRESPONDING METHOD

(71) Applicant: GEMALTO SA, Meudon (FR)

(72) Inventor: Alain Rhelimi, La Ciotat Cedex (FR)

(21) Appl. No.: 14/361,073

(22) PCT Filed: Nov. 29, 2012
(86) PCT No.: PCT/EP2012/073992

§ 371 Date: May 28, 2014

(30) Foreign Application Priority Data
Nov. 29, 2011 (EP) 11306576.7

(51) Int. Cl. H04W 12/06; H04M 1/725

(52) U.S. Cl. CPC H04W 12/06; H04M 1/7253
USPC 726/4

(57) ABSTRACT

The invention relates to a system for pairing a terminal with an element worn on the wrist or hand of a user, the element comprising a secure element for communicating with the terminal. According to the invention: the element contains an accelerometer; the terminal includes a means for recording the movements of the element; the system comprises a means for comparing the signature of the accelerometer with that of the recording means of the terminal in order to authorize, if the signatures are similar, the pairing of the terminal with the secure element.

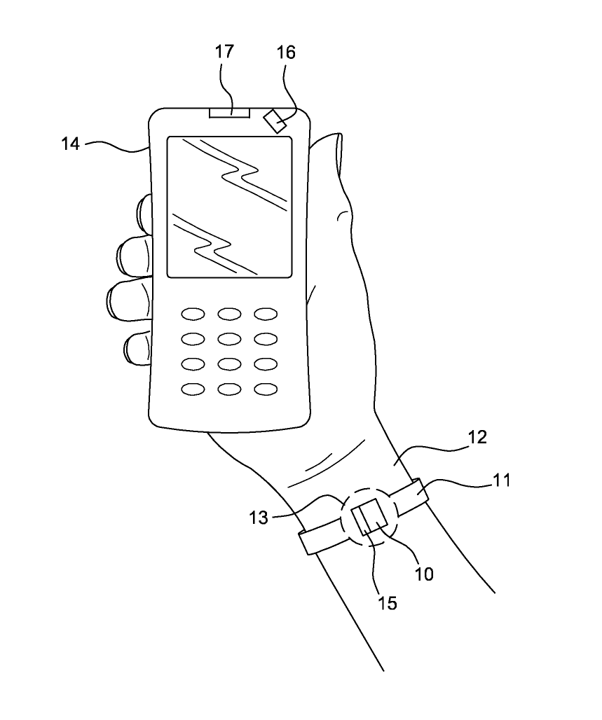

### BACKGROUND

The field of the invention is that of telecommunications and more particularly the authentication of a holder of a smart element of the eGo type.

More specifically, the present invention relates to a system and a method for pairing, on the one hand, a terminal with an element of the eGo type worn on the wrist or the hand of a user.

A first pairing system provides for the pairing, for example, of a mobile phone or a PDA (Personal Digital Assistant), with, on the other hand, a remote secure element.

The telecommunication terminal is preferably a mobile phone. Usually, a mobile phone contains a secure element, such as a Sim or Usim card, or a UICC or even an e-UICC (embedded UICC, i.e. a chip integrated in the mobile terminal (for instance welded in the mobile terminal) acting as the UICC), intended for cooperating with the terminal. The secure element contains elements (keys, directories, software, files, . . . ) enabling the user of the terminal to identify with a typically cellular telecommunications network and to establish communications (voice, data, . . . ). A secure element of this type is compliant with the ETSI standards.

A remote secure element is a secure element which is not present or physically connected to the terminal, but which communicates by radio with this terminal. In a particular embodiment, the secure element may for example be integrated in a device worn by the terminal user and communicate with the terminal via Bluetooth, WiFi or a technology based on the IEEE 802.15.4 standard. A conventional system including a mobile terminal having a UICC card is thus replaced by a terminal having no UICC card but communicating with such card (or an e-UICC) located a few dozens of centimeters to a few meters or dozens of meters away.

The advantage of this solution is that the terminal no longer contains the subscriber's identifier and that it can be lent to anyone wishing to use it: the communication with the network will not be charged to the holder of the device but to the user thereof (assuming of course that the user also has a remote secure element, otherwise it will not be possible to establish a communication). Moreover, as all personal data valuable to the user, like his/her organizer, his/her phone book, his/her photos, . . . are included in the secure element he/she holds, the stealing or the loss of his/her terminal is only a minor inconvenience, as compared to the loss or stealing of the remote secure element containing his/her personal data, his/her rights of access to services or even his/her means of payment.

An ingenious transmission system called eGo is also known. Such a system is described on the site http://www.ego-project.eu and in the patent EP-1.695.296.

An eGo system consists of two components: a first element is included in an element to be controlled. It may be a computer mouse, a cellular phone, a house or car door, etc. . . The second element is carried by the user of the first element: this element enables the first element to identify or authenticate the holder of the second element. The second element is in physical contact with the user, for example it is fastened to his/her belt, worn around his/her neck (badge, necklace) in his/her watch, with the essential point being that a communication of the BCC (“Body-Coupled Communication”) type, can be established between the two elements.

The operation principle is as follows: the holder of the second element authenticates with the second element, for example by entering a code into the device that includes it or by fingerprint recognition. Once authenticated, the holder of the second element comes into physical contact with the element to be controlled (he/she touches the mouse connected to the computer, takes his/her cell phone in his/her hand, touches the handle of the door of his/her home or his/her car) and a communication is established between the first and the second elements on the surface of the holder's skin. If the second element recognizes the first element (a primary pairing has previously been performed between the two elements) then the second one turns on and tries to establish a wireless communication with the first element.

This BCC communication is then interrupted for a wireless communication, for instance in the UWB mode (for Ultra Wide Band as described in the IEEE 802.15.4a standard, for example) to be established between the two elements. The computer or the cellular phone switches from a locked state to an unlocked state (without the user having to enter a password or a PIN code), the lock of his/her home or his/her car is released without having to use a key. During the UWB communication, any device that authenticated the holder communicates with the second element by bidirectional radio waves. This enables the holder not to remain in physical contact with the element to be controlled (the mouse, the phone or the door handle). The holder can stay close to the element to be controlled (up to approx. 20 meters) without the latter being reset to its initial state (locking of the computer or the phone, locking of the lock). If the holder stays too far from the element to be controlled, the UWB communication is interrupted and the computer or the phone automatically locks or the door locks.

Such a system is described in particular in the European patent application No. 11305862.2 entitled: “A system for transmitting data between a communication terminal and a remote secure element”, filed on May 7, 2011.

This patent application claims a system for transmitting data between a telecommunication terminal and a remote secure element wherein the system comprises an interface capable of establishing a UWB communication between the terminal and the secure element.

According to this patent application, the interface may take various forms, for example:
comprise a flexible element having a connector for making electrical contact with corresponding electrical contacts of the terminal, with the connector being electrically connected to a communication element connected to a UWB antenna;
comprise an element acting as a proxy between the terminal and a communication element connected to such a UWB antenna, with this element acting as a proxy being in contact with electrical contacts of the terminal and comprising means enabling a short-range communication with the communication element, and with the communicating element being in mechanical contact with the shell of the terminal;
comprise an element acting as a proxy between the terminal and a communication element connected to a UWB antenna, with the element acting as a proxy being in contact with electrical contacts of the terminal and comprising means enabling a short-range communication with the communication element, with this communication element being positioned in a removable card intended to cooperate with the terminal.

Using such a system, a wireless communication can be established between, on the one hand, a standard terminal, to which only a flexible element of the eGo type, a shell of the eGo type or a card, for example, of the eGo SD or micro-SD type should be added, and on the other hand an element of the eGo type held by the user, with said element cooperating with a secure element, preferably of the e-UICC type.

The eGo-type element held by the user can in particular be attached to his/her wrist, for instance to a wristwatch or inserted into a ring worn at a user's finger. The eGo type element can thus be firmly secured to the user's wrist, without being loosely attached to the user, as would be the case for example if it were fastened to a bracelet, a necklace or a badge.

### SUMMARY

The present invention first provides a solution to the following problem:

If a person, which holds no eGo type device, maliciously (or inadvertently) touches, with an eGo-compatible portable terminal, such as a mobile phone, the holder of an eGo type element (including or cooperating with a secure element of the e-UICC type) he/she establishes a BCC type communication between the terminal and the holder of the eGo type element through this simple physical contact. Unintended pairing from the holder of the eGo/e-UICC elements thus occurs. The terminal and the e-UICC then communicate in UWB mode without the holder of the e-UICC knowing it. The malicious person can then use the terminal to establish communication with the telecommunications network, using the identifiers of the holder of the e-UICC. So the call made by the malicious person will be charged to the holder of the e-UICC equipped with the eGo type device. The solution to this problem, which consists in preventing an eGo-compatible telecommunication terminal physically touching the holder of a e-UICC connected to an eGo type device from pairing with the eGo type device, is precisely one of the objects of the present invention.

A second pairing system according to the invention provides to pair for instance a mouse connected to a remote computer and secure element of the eGo type also worn on the wrist or finger of the user.

It is here proposed to pair the computer (via the mouse) to the remote secure element. In the prior art, to provide access to a computer to a user, the latter must enter a password. The second pairing system according to the invention makes it possible to avoid entering such a password.

A third pairing system of the invention provides to check the agreement of any holder of an eGo type element to a transaction, for example a bank transaction: in the state of the art, this OK is based on the entry of a code into a payment terminal, after having inserted the user's credit card.

The invention relates to a system for pairing a terminal with an element worn on the wrist or the hand of a user, with the element comprising a secure element for communicating with the terminal.

According to the invention:
the element contains an accelerometer;
the terminal includes means for recording the movements of the terminal;
the system comprises a means for comparing the signature of the accelerometer and that of the recording means of the terminal in order to authorize the pairing of the terminal with the secure element if the signatures are similar.

The element is preferably of the eGo type.

Advantageously, the terminal is a mobile terminal supporting the eGo technology.

Preferably, the mobile terminal communicates with the secure element and the secure element supports functions of the UICC type.

According to one embodiment, the device is a computer mouse connected to a computer and the computer includes means for recording the movements of the computer mouse and the element.

In another embodiment, the terminal is a pad or a tablet comprising optical or touch-sensitive means for recording the movements of the element.

Preferably, the element is integral with the user's wrist watch or ring.

Advantageously, the means for comparing the signature of the accelerometer with that of the recording means in order to authorize the pairing of the terminal with the secure element, if the signatures are similar, are included in the element.

Preferably, the secure element is an e-UICC.

The invention also relates to a method for pairing a terminal and an element that the user wears on his/her wrist or hand, with the element comprising a secure element intended to communicate with the terminal. According to this method:
the element contains an accelerometer;
the terminal includes a means for recording the movements of the element;
the method consisting in comparing the signature of the accelerometer with that of the recording means in order to authorize the pairing of the terminal with the secure element if the signatures are similar.

### BRIEF DESCRIPTION OF THE DRAWINGS

Other characteristics and advantages of the present invention will become apparent upon reading the following description of several embodiments of the system according to the invention, given by way of illustration and not limitation, wherein:

The accompanying single FIGURE shows a system for pairing a mobile terminal of the eGo type with an element of the eGo type worn on the wrist of a user.

### DETAILED DESCRIPTION

In the single FIGURE, an element 10 of the eGo type is worn, using a wristband 11 on the wrist 12 of a user. The eGo-type device 10 is, for instance, integrated in a watch or placed in a housing provided in the watch 13. The eGo-type element 10 is in physical contact with the wrist 12 of the user and cooperates with a secure element intended to communicate with a terminal, a mobile terminal 14 here. The secure element is typically a chip fulfilling the function of a UICC and will be called an e-UICC in the following. Thus, the terminal 14 itself does not contain an e-UICC or a UICC, but the latter is remote, and positioned in the eGo device 10.

The eGo device 10 may also be integrated in a ring worn by one of the user's fingers.

It is known that the elements of the eGo type must have multiple antennas, notably antennas enabling communication in UWB mode. This or these antenna(s) may be integrated in the wristband 11.

According to the invention, in order to achieve a pairing of the eGo element 10 with the terminal 14, which is eGo-compatible, i.e. that supports the eGo technology to communicate, more particularly includes UWB means for communicating with the element 10, the eGo element 10 cooperates with, or contains an accelerometer 15, and the terminal 14 is provided with an accelerometer 16, too. The latter is for example positioned close to the earphone 17 of the terminal 14.

Each accelerometer 15 and 16 is associated with means (not shown) for detecting and recording the movements which they have been submitted to (a rotation, a horizontal or vertical reciprocating movement, the handwritten signature of the user, . . . ). These records are then called signatures. The accelerometers are preferably so positioned that the signatures thereof are identical or very similar when the user firmly holds the terminal 14 in his/her hand and makes a gesture. The signatures cannot be identical, at best they may be close, because the amplitudes thereof will be different and it may be necessary to observe, in some cases, parasite hand movements that would not occur in the wrist. Recording the main components of the movements is sufficient, depending on the safety level expected to authorize the pairing.

According to the invention, a means (not shown) for comparing the signatures of the accelerometers is provided in the eGo type element or in the mobile terminal 14.

Such comparing means compares the signatures of the accelerometers 15 and 16 during or after the above-mentioned CCB communication or during the UWB communication. To do this, a transmission via BCC or UWB of the signature of the accelerometer contained in the terminal 14 is either transmitted to the comparing means if it is included in the eGo element 10, or the one contained in the eGo element 10 is transmitted to the comparing means if the latter is included in the terminal 14.

The comparing means compares the two signatures. If these are similar (a similarity value of about 90% is correct to authorize a pairing of the mobile terminal 14 of the eGo type with the eGo type element 10 worn on the wrist 12 of the user) the comparing means authorizes the pairing of the terminal 14 with the e-UICC included in the element 10. A communication can then be made by the user. On the contrary, if the signatures are not sufficiently similar, this pairing will not be authorized and the terminal 14 will not be able to work. This system thus prevents a malicious person having the terminal 14 and not equipped with an element (like a bracelet or a watch) of the eGo type from pairing his/her terminal 14 and the e-UICC 10 since he/she has not made the gesture of the holder of the element 10 while holding the terminal 14 in his/her hand.

It is of course particularly preferred for the element 10 and the accelerometer 15 to be held in one's hand holding the terminal 14 in order to increase the rate of successful pairing. An element 10 attached to a belt or to a badge can not be paired with the terminal 14.

The means for comparing the signatures of the accelerometers are preferably contained in the element 10 to prevent a maliciously modified terminal from authorizing the pairing even though the latter should not have been authorized (a comparing means systematically authorizing the pairing as soon as the holder of the eGo element 10 is touched by the terminal—in reference to a credit card of the “yes-yes” type).

In a second embodiment of the system according to the invention, the terminal is a computer mouse connected to a computer. The mouse contains an accelerometer or a movement detector (for example an optical one), and transmits the signature saved by the user of the mouse to the computer. The latter comprises a means for recording the movements of the mouse. In parallel, the eGo type element worn by the user containing an accelerometer records the movements of this element. The signature of the movements of the mouse is transmitted to the eGo type element and, if the signatures are very similar, the user is identified as being authorized to access the computer, for example, without having to enter a password. The secure element embedded in the eGo type device has no embedded e-UICC but simply compares the two signatures. This prevents a malicious person from touching the holder of an element of the eGo type with the computer mouse to access the latter: only the holder of the eGo element is authorized to access the computer since he/she will have made the gesture that will be compared with the one recorded by the mouse and transmitted to the computer. The mouse itself can contain the means for recording the movements which it has been submitted to and retransmit these to the eGo element held by the user, but this increases the price of the mouse whereas simple software installed in the computer is capable of performing these functions (saving and transmission).

In a third embodiment of the system according to the invention, the terminal is a pad or a touch-sensitive tablet such as a so-called SURFACE 2.0 pad described, for example, on the website http://www.clubic.com/salon-informatique-tic/ces/actualite-389144-surface-2-retour-table-tactile-microsoft.html. It may also be a computer keypad used as a mouse.

A SURFACE 2.0 pad uses a so-called “Pixel Sense” technology wherein infrared cameras are located under a transparent panel (for instance, a window) whereon users can use their hands to scroll through applications, get access to websites, as the user of a mobile terminal would use the touch-sensitive functions of the terminal. Each pixel of the pad becomes a camera and the set of pixels browsed by the user's hand thus enables the generation of a signature as described above. It is thus possible to obtain the pairing of an element of the eGo type worn on the user's wrist with the touch-sensitive pad.

By comparing the signatures of the touch-sensitive pad and that of the accelerometer included in the eGo type element worn on the user's wrist, it is possible to verify the user's explicit wish (agreement) to use the secure element with the touch-sensitive pad, for example for payment applications. After the pairing, payment may be authorized, for instance through NFC.

In a shop, the handwritten signature or any other gesture made by the user using the eGo type element worn on his/her wrist on a touch-sensitive tablet, for example, thus makes it possible to make an UWB connection between the pad connected to a payment terminal (or directly to the payment terminal) and the secure element associated with the eGo device worn by the user. For example, this UWB connection thus authorizes to make a payment to a shopkeeper if the secure element is equipped with a banking application.

The invention also relates to a method for pairing a terminal with an element of the eGo type worn on the wrist or the hand of a user, with the eGo type element comprising a secure element intended to communicate with the terminal. In this method:
the element of the eGo type contains an accelerometer
the terminal includes means for recording the movements of the eGo type element;
the method consists in comparing the signature of the accelerometer with that of the recording means in order to authorize the pairing of the terminal with the secure element if the signatures are similar.

1. A system for pairing a terminal with an element worn on the wrist or hand of a user, with said element comprising a secure element intended for communicating with the terminal, wherein:
said element contains an accelerometer as well as first means for recording the movements to which it is submitted, with such first recording means supplying a first signature;
said terminal includes second means for recording the movements of the terminal, with such second recording means supplying a second signature; and
the system includes means for comparing said first and second signatures to authorize the pairing of the terminal with said secure element if said signatures are similar.

2. A system according to claim 1, wherein said element is of the eGO type, to which an accelerometer is added.

3. A system according to claim 1, wherein said terminal is a mobile phone supporting the eGo technology.

4. A system according to claim 1, wherein said mobile terminal communicates with said secure element and wherein said secure element supports functions of the UICC type.

5. A system according to claim 1, wherein said terminal is a computer mouse connected to a computer and wherein said computer includes a means for recording said movements of said computer mouse and said element.

6. A system according to claim 1, wherein said terminal is a pad or tablet computer comprising optical or touch-sensitive means for recording the movements of said element.

7. A system according to claim 1, wherein said element is integral with a wristwatch or a ring of said user.

8. A system according to claim 1, wherein said means for comparing the signature of said accelerometer and that of said recording means to authorize the pairing of said terminal with said secure element, if said signatures are similar, are included in said element.

9. A system according to claim 1, wherein said secure element is an e-UICC.

10. A method for pairing a terminal with an element worn on the wrist or hand of a user, the element comprising a secure element for communicating with the terminal, wherein:
said element contains an accelerometer as well as first means for recording the movements to which it is submitted, with such first recording means supplying a first signature;
said terminal includes second means for recording the movements of the terminal, with such second recording means supplying a second signature;
with said method comprising comparing the first and second signatures to authorize the pairing of the terminal with said secure element if said signatures are similar.
